(19) United States
(12) Patent Application Publication
(10) Pub. No.: US 2016/0315871 A1
(43) Pub. Date: Oct. 27, 2016

(54) METHOD FOR PROCESSING FAILURE OF NETWORK DEVICE IN SOFTWARE DEFINED NETWORKING (SDN) ENVIRONMENT

(71) Applicant: KT CORPORATION, Seongnam-si (KR)

(72) Inventors: Eun Joo KWAK, Daejeon (KR); Kwang Koog LEE, Daejeon (KR); Young Wuk LEE, Daejeon (KR)

(73) Assignee: KT CORPORATION, Seongnam-si (KR)

(21) Appl. No.: 15/103,524

(22) PCT Filed: Dec. 11, 2014
(86) PCT No.: PCT/KR2014/012220

§ 371 Date: Jun. 10, 2016

(30) Foreign Application Priority Data
Dec. 11, 2013 (KR) 10-2013-0154015
Dec. 10, 2014 (KR) 10-2014-0177257

(51) Int. Cl. H04L 12/911; H04L 12/721; H04L 12/26; H04L 12/947

(52) U.S. Cl. CPC H04L 47/70; H04L 49/25; H04L 45/70; H04L 43/0823

(57) ABSTRACT

Disclosed is a method for processing a failure occurring in a network device. The method for processing the failure, performed in a network device connected to at least one controller, comprises the steps of: predicting the failure of the network device; and when the failure of the network device is predicted, notifying at least one controller that the network device will be down. Accordingly, by defining a processing mechanism for each type of router failure, all controllers concerned can quickly grasp the failure information of the router.

### TECHNICAL FIELD

The present disclosure relates to a software defined networking technology, and more particularly to a method for processing a failure occurring in a network apparatus.

### BACKGROUND ART

A software-defined network (SDN) technology, which defines a network in a software manner, and controls the network centrally by separating a communication system into a forwarding plane and a control plane for flexible control and cost saving of a communication network, has been introduced.

In accordance with such the trend, an internet engineering task force (IETF) is defining standard interfaces of a router and an external controller which are used for centrally collecting router information through the external controller and applying routing system control policies so as to introduce the concept of SDN without modifying functions of the conventional routers.

More specifically, the IETF proposes an interface to routing system (I2RS) technology which supports central controls using an external controller even for a routing system including a legacy IP routing system in which a forwarding plane and a control plane are not separated.

That is, the IETF is proceeding with standardization of the routing system interface technology for routing systems, and defining frameworks and interfaces, which enable communications between a controller and legacy or new router apparatuses.

However, there are not discussions on methods for processing a failure of a network apparatus such as a router in the SDN network.

### DISCLOSURE

### Technical Problem

The purpose of the present invention for resolving the above-described problem is to provide a method for processing a failure of a network apparatus such as a router in a SDN environment.

### Technical Solution

In order to achieve the above-described purpose of the present invention, a method for processing a failure, performed in a network apparatus connected to at least one controller, according to an aspect of the present invention, may comprise predicting a failure of the network apparatus; and when the failure of the network apparatus is predicted, notifying the at least one controller that the network apparatus will be down.

Here, when the failure of the network apparatus is predicted, the network apparatus may notify the at least one controller that the network apparatus will be down by including information on a time at which the network apparatus will be down.

Here, a time stamp generated by the network apparatus may be used as the information on the time at which the network apparatus will be down.

Here, the notifying the at least one controller that the network apparatus will be down further includes: searching a storage part storing a list of the at least controller for a controller related to the network apparatus; and transmitting, to the searched controller, a message notifying that the network apparatus will be down.

Here, a message broker may relay messages between the at least one controller and the network apparatus.

In order to achieve the above-described purpose of the present invention, a method for processing a failure, performed in a network apparatus connected to at least one controller, according to another aspect of the present invention, may comprise restarting after recovering a failure; and transmitting information on the restarting to the at least one controller in order to notify the failure to the at least one controller.

Here, in the transmitting information on the restarting to the at least one controller, an unpredictable failure occurring in the network apparatus may be notified to the at least one controller by using the information on the restarting.

Here, the failure of the network apparatus may be notified to the at least one controller, by including information on a number of restarts of the network apparatus in the information on the restarting.

Here, the transmitting information on the restarting to the at least one controller may further include searching a storage part storing a list of the at least controller for a controller related to the network apparatus; and transmitting, to the searched controller, the information on the restarting.

Here, a message broker may relay messages between the at least one controller and the network apparatus.

In order to achieve the above-described purpose of the present invention, a method for processing a failure, performed in a network apparatus connected to at least one controller, according to yet another aspect of the present invention, may comprise receiving information according to a type of a failure occurring in the network apparatus from the network apparatus; and processing the failure based on the information according to the type of the failure.

Here, the information according to the type of the failure may include information notifying that the network apparatus will be down, when the failure of the network apparatus is predictable; or information notifying that the network apparatus has been restarted, when the failure of the network apparatus is unpredictable.

Here, in the receiving information according to the type of the failure, information on a time at which the network apparatus will be down may be received, when the failure of the network apparatus is predictable.

Also, a time stamp generated by the network apparatus may be used as the information on the time at which the network apparatus will be down.

Here, in the receiving information according to the type of the failure, information on a number of restarts of the network apparatus may be received when the failure of the network apparatus is unpredictable.

Here, in the processing the failure based on the information according to the type of the failure, transmission of a message to be transmitted to the network apparatus in which the failure occurs may be suspended, and the message may be recorded in a log.

Here, a message broker may relay messages between the at least one controller and the network apparatus.

### Advantageous Effects

The above-described method for processing a failure of a network apparatus, according to an exemplary embodiment of the present invention, defines a processing mechanism for a graceful failure and a crash so that all controllers related to the network apparatus can identify information on the failure.

Also, after the failure occurred in the router, the controller may suspend (pause) transmission of all messages for the corresponding router by recording the messages in a log according to information on the graceful failure or the crash, so as to reduce unnecessary trials of retransmissions and loads of a network.

### DESCRIPTION OF DRAWINGS

FIG. 1 is a block diagram to explain a structure of a routing system according to an exemplary embodiment of the present invention.

FIG. 2 is a sequence chart to explain a method for processing a failure of a network apparatus according to an exemplary embodiment of the present invention.

FIG. 3 is a conceptual view to explain publish/subscribe mechanism for an event using a message broker according to an exemplary embodiment of the present invention.

FIG. 4 is a sequence chart to explain publish/subscribe mechanism for an event using a message broker according to an exemplary embodiment of the present invention.

FIG. 5 is a sequence chart to explain a method for processing a failure of a network apparatus by using a message broker according to an exemplary embodiment of the present invention.

FIG. 6 is a flow chart to explain a method for a message broker to process a failure predicted for a network apparatus according to an exemplary embodiment of the present invention.

FIG. 7 is a sequence chart to explain to explain a method for processing a failure predicted for a network apparatus according to an exemplary embodiment of the present invention without a message broker.

FIG. 8 is a sequence chart to explain a method for processing an unpredictable failure of a network apparatus by using a message broker, according to an exemplary embodiment of the present invention.

FIG. 9 is a flow chart to explain a method for processing an unpredictable failure of a network apparatus by using a message broker, according to an exemplary embodiment of the present invention.

FIG. 10 is a sequence chart to explain a method for processing an unpredictable failure of a network apparatus without a message broker, according to an exemplary embodiment of the present invention.

### BEST MODE

While the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is meant to cover all modifications, equivalents, and alternatives falling within the spirit and scope of the invention. Like numbers refer to like elements in the accompanying drawings.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a ‘controller’ in the specification means a functional entity controlling related components (for example, switches, routers, etc.) in order to control flows of traffic. Also, the controller is not restricted to a specific physical implementation or a specific implementation position. For example, the controller may mean a controller functional entity defined in ONF, IETF, ETSI, or ITU-T.

A ‘network apparatus’ in the specification means a functional entity performing traffic (or, packet) forwarding, switching, or routing. Accordingly, in the specification, the network apparatus may also be referred to as a ‘switch’ or ‘router’. For example, the network apparatus may mean a switch, a router, a switching element, a routing element, a forwarding element, etc. defined in ONF, IETF, ETSI, or ITU-T.

Also, exemplary embodiments of the present invention which will be explained in the below description may be supported by standard specifications of ONF, IETF, ETSI, or ITU-T that are performing standardization on SDN technologies, and standard specifications of IEEE, ITU-T, or IETF that are performing standardization on transport network technologies. That is, parts of exemplary embodiments according to the present invention, explanations on which are omitted for clarifying the technical sprit of the present invention, may be supported by the standard specifications of the above-described standardization organizations. Also, all terminologies used in the present specification may be explained based on the above standard specifications.

Hereinafter, preferred exemplary embodiments according to the present invention will be explained by referring to accompanying figures.

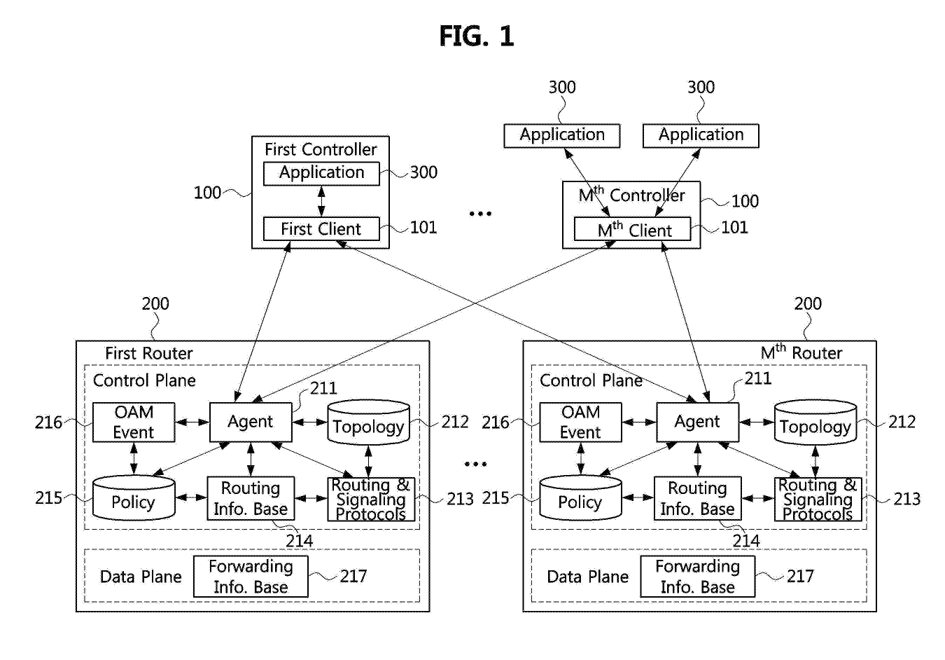

FIG. 1 is a block diagram to explain a structure of a routing system according to an exemplary embodiment of the present invention.

Referring to FIG. 1, there may be a plurality of network apparatuses (e.g. routers) 200 controlled by controllers 100, and the controller 100 controlling the routers 200 may be configured plurally for load distribution and reliability.

In FIG. 1, a case, in which M controllers 100 including first to M^{th} controllers control N routers 200 including first to M^{th} routers, is illustrated.

Each of the controllers 100 may interwork with network applications 300. Also, each of the controllers 100 may interwork with one or more network applications 300. For example, each of the controllers 100 may provide necessary information to the application 300, or perform operations according to requests of the application 300.

Specifically, FIG. 1 illustrates a structure in which an agent module 211 existing in a control plane of a router 200 communicates with a client module 101 existing in the controller 100 via a standardized routing system (e.g. Interface to Routing System (I2RS)).

The client module 101 may receive a routing policy or a control command from the application 300, and perform a function of translating the received policy or control command into a form which the agent module 211 can parse, or a function of forwarding the translated message.

The agent module 211 may parse the forwarded policy or control information, and perform interoperations with a topology database (DB) 212, a policy DB 215, a routing information base (RIB) module 214, a routing/signaling protocol module 213, and an OAM event module 216 which are connected with each other in the router 200.

Also, a forwarding information base (FIB) module 217 may exist in a data plane of the router 200. Therefore, information from the agent module 211 may be transferred to the forwarding information based module 217 of the data plane via the routing information base module 214.

Furthermore, various event information or statistics information of the routers 200 which are preconfigured by an operator may be transferred to the client module 101 via the agent module 211 by using a monitoring function.

The agent module 211 in the router 200, which is responsible for communications with the controller 100 via a standard interface, may be very important in an aspect of stability and reliability of the routing system.

However, a processing structure and mechanism for a failure of the agent module 211 is not defined until now. That is, although a standardization group of I2RS is discussing about router failures (or, agent failures), a specific mechanism is not defined yet. Thus, it is needed to define appropriate processing manners on router failures or agent failures.

Meanwhile, in the I2RS environment, definition of requirements on a protocol is needed in an aspect of message transmission manner. In the environment in which a plurality of controllers 100 operate as connected with a plurality of routers 200 as illustrated in FIG. 1, the number of relations, which each of the controllers 100 and routers 200 should manage for messages transferred via an interface between the controller 100 and the router 200, may increase as the number of the controllers 100 and the routers 200 increases.

For example, in a case that all of N routers 200 and M controllers 100 respectively have inter-relations, the number of relations which should be managed may be N×M.

Also, when a new router or controller is added in the network, all controllers or routers affected by the new router or controller should perform operations of adding the new router or controller. This may cause a problem of scalability.

Therefore, the present invention provides a method for processing router failures or agent failures, and a method for enhancing a publish/subscribe mechanism of the I2RS interface message such as a router failure or an agent failure.

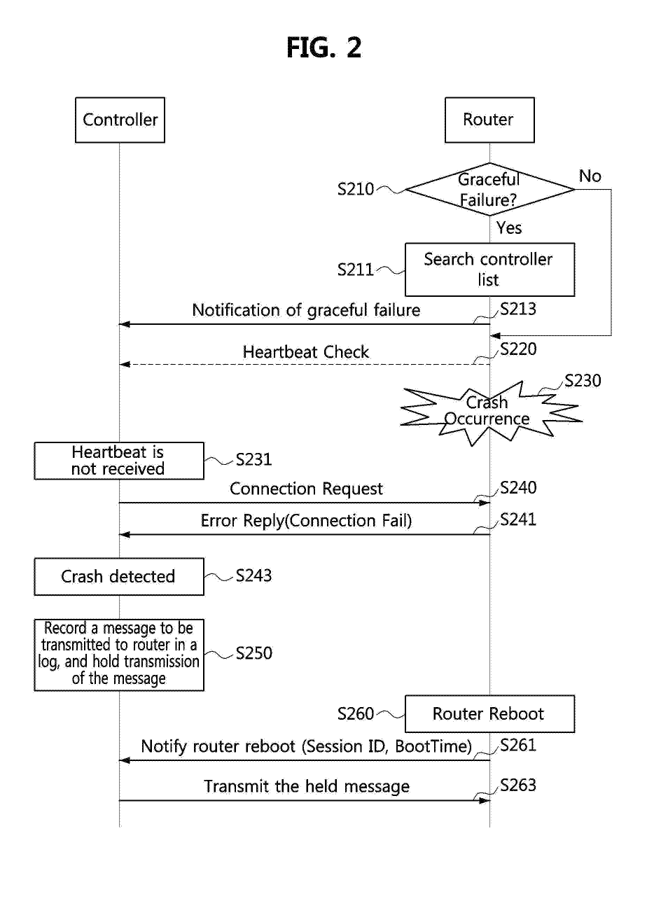

FIG. 2 is a sequence chart to explain a method for processing a failure of a network apparatus according to an exemplary embodiment of the present invention.

Referring to FIG. 2, the router 200 may classify a failure according to predictability of the failure (S210). For example, the router 200 may classify a case in which a predictable shutdown or failure occurs as a graceful failure, and a case in which a failure occurs abruptly as a crash.

When the graceful failure is predicted, the router 200 may identify information on all controllers 100 connected to the router 200 (S211), and notify the identified controller 100 that the router will be down (S213). Here, the controller 100 may record a message to be transmitted to the router 200 in a log, and suspend the transmission.

An unpredictable crash may occur in the router 200 (S230). In this case, the controllers 100 may not predict the failure of the router 200. Therefore, in order to rapidly detect the router 200 in which the crash occurs, the router 200 may transmit messages for health-checking such as heartbeat messages to the controller 100 (S220). However, the transmission of the heartbeat messages by the router 200 may be performed optionally.

The controller 100 may not receive the heartbeat message from the router 200, or may not detect the crash occurring in the router 200 in a specific period (S231). In this case, the controller 100 may request a connection for transmitting a message to the router 200 (S240). Since the router 200 is in state of crash, the controller 100 may receive a reply message such as a ‘connection fail’ (S241).

Thus, the controller may detect the crash occurring in the router 200, when the heartbeat message is not received or when the error reply such as the ‘connection fail’ is received (S243).

The controller 100 may record a message to be transmitted to the router 200 which is in state of crash in a log, and suspend the transmission (S250). Also, the controller 100 may query a list of other controllers related to the router 200 and notify the failure of the router to other controllers.

Meanwhile, even when the heartbeat message is not received, or when the error reply message such as the connection fail is received, the crash occurring in the router 200 may not be detected. The processing for this case may be explained as follows.

The router 200 may be rebooted after resolving the crash (S260). After the router 200 is restarted, the router 200 may notify its restart to all controllers related to it (S261). Here, the notification may be performed by including information on a session ID, a boot count, a boot time, etc. in order to separate a current session from a previous session. Here, the boot count may indicate how many times the router 200 has been rebooted.

After the restart of the router 200, the controller may retransmit or delete messages which were not transmitted due to the failure of the router 100 according to a policy (S263). For example, according to types of messages, messages related to QoS, statistics, or events may be retransmitted. On the contrary, all of messages related to change of topology and RIB may be deleted. Alternatively, all messages as earlier as one hour or more than a current time may be deleted, but all messages within 1 hour from a current time may be retransmitted according to a policy.

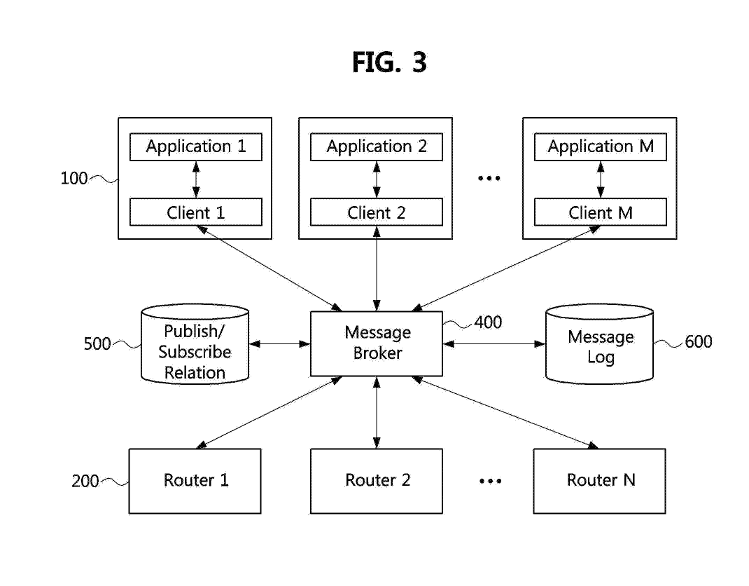

FIG. 3 is a conceptual view to explain publish/subscribe mechanism for an event using a message broker according to an exemplary embodiment of the present invention.

Referring to FIG. 3, in a case that various messages are exchanged between the controller 100 and the router 200, a publish/subscribe mechanism may be used in order to reduce dependency between the controller 100 and the router 200, and reduce burden of session management.

Also, a message broker (MB) 400 may be utilized for reducing inter-dependency between the controller 100 and the router 200, and reduce complexity and burden of relation management between multiple controllers 100 and routers 200.

The message broker 400 may relay messages between the plurality of controllers 100 and the plurality of routers 200. For example, the message broker 400 may relay messages between the plurality of controllers 100 and the plurality of routers 200 by referring to a publish/subscribe relation DB 500, and store information on message exchanges in a message log DB 600.

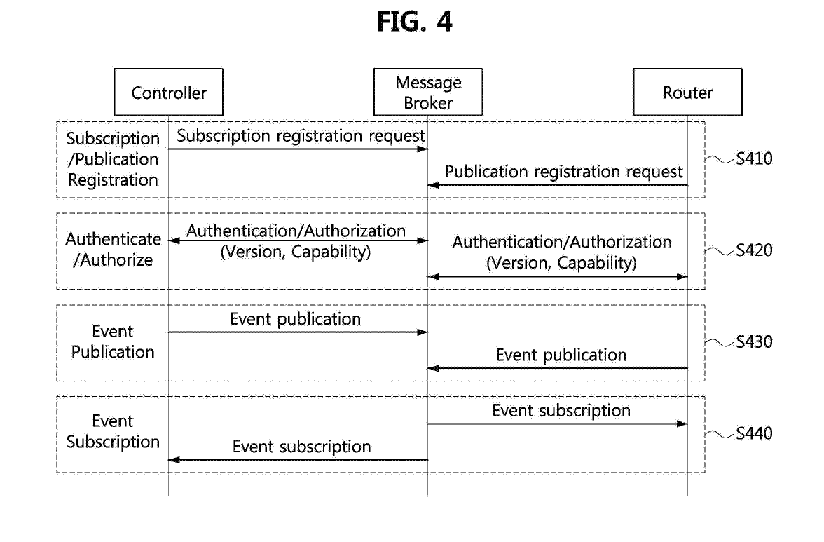

FIG. 4 is a sequence chart to explain publish/subscribe mechanism for an event using a message broker according to an exemplary embodiment of the present invention.

Referring to FIG. 4, a method for publishing and subscribing an event by using a message broker, according to an exemplary embodiment of the present invention, may comprise a step S410 of subscription/publication/registration, a step S420 of authentication/authorization, a step S430 of event publication, and a step S440 of event subscription.

Referring to FIG. 4, messages used in each step will be explained as follows.

FIG. 4 illustrates an exemplary embodiment for messages and parameters used in each step of the method for publishing and subscribing an event using a message broker (MB) 400.

First, the step S410 of subscription/publication/registration may be performed by using a subscription registration request message and a publication registration request message.

The controller 100 may transmit the message for requesting registration of subscription to the message broker 400, and the router 200 may transmit the message for requesting registration of publication to the message broker.

Thus, the message broker 400 may receive the subscription registration request message and the publication registration request message, and identify the controller 100 requesting the subscription and the router 200 requesting the publication. Also, the messages used for the step S410 of subscription/publication/registration may include information listed in the below table 1.

That is, a publisher and a subscriber may be identified by using the information of the table 1. Also, registration, pause, resume, deregistration, etc. may be performed by using information on an ‘Order Type’.

TABLE 1

| Parameter | Description | Remarks |
|---|---|---|
| Msg id | Message ID | |
| Requester id | ID of a controller or a | Identification information of a |
| | router requesting | controller or a router |
| | registration | requesting registration |
| Order Type | request status | Registration, Pause, Resume, |
| | | Deregistration |
| Role | Indicating a role to register | Publisher or Subscriber |
| Event Type | Type of an event to publish | Policy, Routing Information, |
| | or subscribe | Fault, Statistics, etc |
| Time Stamp | Request time | Request time of a registration |
| | | request message |

In the step S420 of authentication/authorization, authentication and authorization between the message broker 400 and each of the controller 100 and the router 200 may be performed. That is, the message broker 400 and each of the controller 100 and router 200 may perform authentication with each other, and perform requests and assignments of tights according to each role.

Also, the messages used for the step S420 of authentication/authorization may include information listed in the below table 2.

TABLE 2

| Parameter | Description | Remarks |
|---|---|---|
| Msg id | Message ID | |
| Requester id | ID of a message broker, a | Identification information of a |
| | controller, or a router | message broker, a controller, |
| | requesting authentication/ | or a router requesting |
| | authorization | authentication |
| Order Type | request status | Registration, Pause, Resume, |
| | | Deregistration |
| Role | Indicating a role to register | Publisher, Subscriber, or |
| | | Message broker |
| Event Type | Type of an event to publish | Policy, Routing Information, |
| | or subscribe | Fault, Statistics, etc. |
| Time Stamp | Request time | Request time of a request |
| | | message |

In the step S430 of event publication, the message broker 400 may receive an event issued by the controller 100 or the router 200.

In the step S440 of event subscription, the message broker 400 may notify the event issued by the controller 100 or the router 200 to the router 200 and the controller 100.

Also, the messages used for the step S430 of event publication and the step S440 of event subscription may include information listed in the below table 3.

TABLE 3

| Parameter | Description | Remarks |
|---|---|---|
| Msg id | Message ID | Identifier of a subscription |
| | | message |
| Publisher id | ID of a controller or a | |
| | router issuing an event | |
| Subscriber | ID of a controller or a | |
| ID | router subscribing an event | |
| Priority | Priority of a message | Delay or loss should be |
| | | reduced for a message |
| | | with higher priority |
| Event Type | Type of event | Policy, Routing Information, |
| | | Fault, Statistics, etc. |
| Event | Event Message | Detail Message for Router |
| Message | | shutdown, Agent Crash, |
| | | Agent Reboot, etc. |
| Event Time | Event occurrence time | Router boot time, Router |
| | | shutdown time, etc. |
| Time Stamp | Message request time | Request time of a subscription |
| | | message |

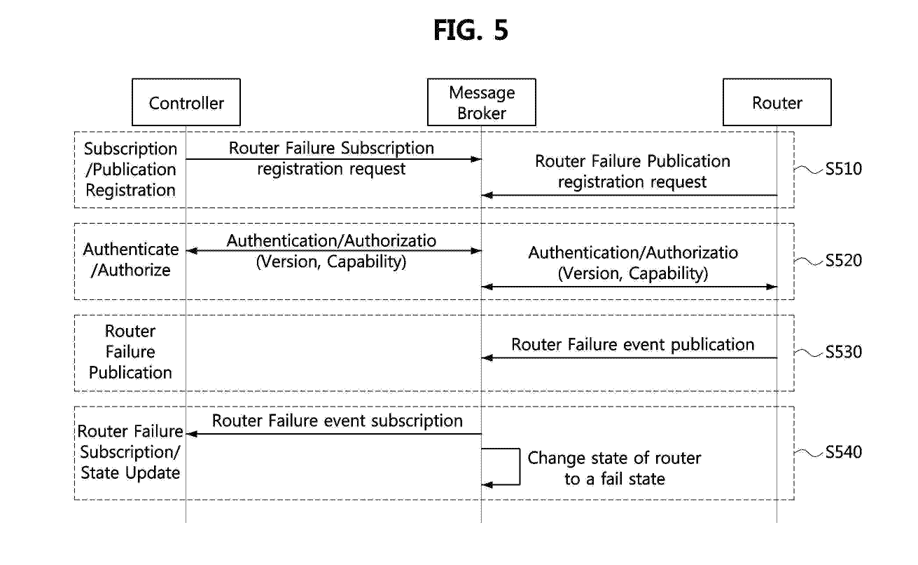

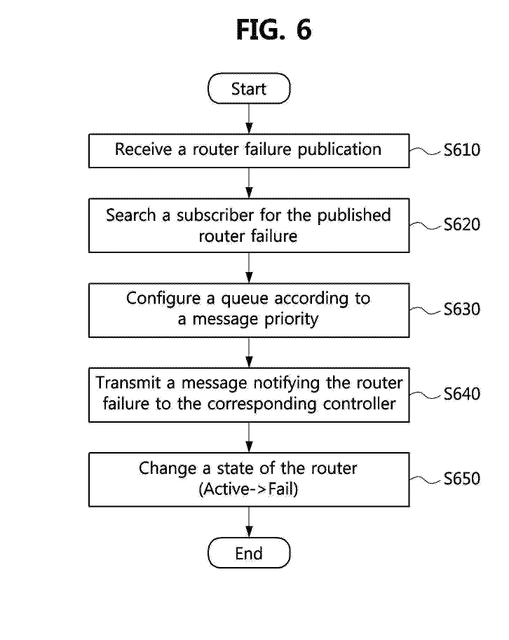

FIG. 5 is a sequence chart to explain a method for processing a failure of a network apparatus by using a message broker according to an exemplary embodiment of the present invention, and FIG. 6 is a flow chart to explain a method for a message broker to process a failure predicted for a network apparatus according to an exemplary embodiment of the present invention.

FIG. 5 illustrates a procedure for processing a graceful failure in a structure having the message broker 400.

Referring to FIG. 5, the method for processing a failure predicted for a network apparatus by using the message broker 400, according to an exemplary embodiment of the present invention, may comprise a step S510 of subscription/publication registration, a step S520 of authentication/authorization, a step S530 of router failure publication, and a step S540 of router failure subscription. Here, each step of FIG. 5 may correspond to each step of FIG. 4.

Specifically, the controller 100 may request registration of subscription of a router failure to the message broker 400, and the router 200 may request registration of publication of a router failure to the message broker 400 (S510).

The message broker 400 and each of the controller 100 and the router 200 having registered the requested subscription and publication may authenticate each other, and request and assign rights according to each role (S520).

According to an occurrence of a router failure, the router 200 may issue a router failure event to the message broker 400 (S530).

Accordingly, the message broker 400 may transfer the router failure event to the controller 100 having requested the subscription, and change a state of the router 200 to a failure state (S540).

FIG. 6 explains the steps S530 and S540 of FIG. 5 more specifically.

Referring to FIG. 6, the router 200 may publish a router event failure, and the message broker 400 may notify the failure of the router 200 to the controller 100. Also, the message broker 400 may change a state of the router 200 in which the failure occurred to a failure state.

The message broker 400 may receive publication of the router failure, and record it in a message log (S610).

The message broker 400 may search publish/subscribe relation information for the corresponding controller 100 which is a subscriber connected to the router 200 (S620).

Also, the message broker 400 may put a message for notifying the router failure into a transmission queue according to a priority of the message, and notify the router failure to the corresponding controller 100 (S630, S640). Here, messages are put into the transmission queue and processed according to their priorities so that emergent or important messages having higher priorities can be transmitted without delay or loss.

Finally, the message broker 400 may change the state of the corresponding router 200 in which the router failure occurred to a failure state (S650).

The case, in which messages between the controller 100 and the router 200 are processed by the message broker 400 as illustrated in FIG. 5 and FIG. 6, may have the following advantages.

It can be centrally managed by the message broker 400 whether a connection relation between the controller 100 and the router 200 is maintained or disconnected (i.e. due to the router failure, etc.).

Since the message broker 400 is finally responsible for subscription and publication, a burden of transmitting messages between the controller 100 and the router 200 may be reduced.

Even in a case that the controller 100 or the router 200 cannot transmit a message due to a failure, the message broker 400 may transmit the message asynchronously by storing the message in the message log. For example, the message broker 400 may store a message in the message log when a router failure occurs, and transmit the stored message when the router failure is recovered.

The message broker 400 may generally manage priorities of messages, and guarantee transmission of the messages according to priorities of the messages when congestion occurs in message transmission. Therefore, stability and reliability of the network can be enhanced by rapidly transferring events occurring in the network.

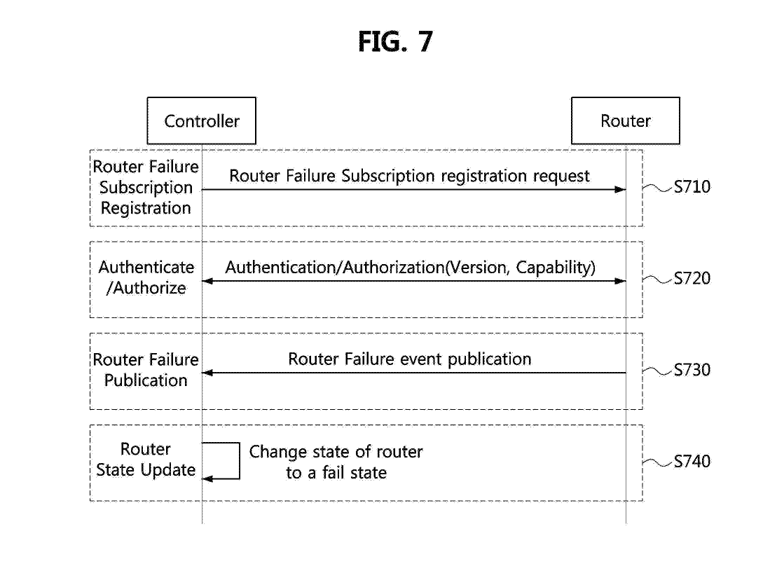

FIG. 7 is a sequence chart to explain to explain a method for processing a failure predicted for a network apparatus according to an exemplary embodiment of the present invention without a message broker.

Referring to FIG. 7, differently from the exemplary embodiment of FIG. 5, the controller 100 and the router 200 may process a failure without the message broker 400, through direct information exchanges between the controller 100 and the router 200.

That is, the controller 100 and the router 200 may respectively perform authentication on each other, and manage connection information for each other.

Specifically, the method for processing a failure without the message broker 400, according to an exemplary embodiment of the present invention, may comprise a step S710 of subscription/publication registration, a step S720 of authentication/authorization, a step S730 of router failure publication, and a step S740 of router failure subscription. Here, each step of FIG. 7 may correspond to each step of FIG. 4.

The controller 100 may request registration of a router failure subscription to the router 200 (S710).

The controller 100 and the router 200 may perform authentication on each other, and perform request and assignment of rights according to each role (S720).

The router 200 may publish a router failure to the controller 100 according to occurrence of the router failure (S730).

The controller 100 may change a state of the corresponding router 200 to a failure state (S740).

Therefore, the method for processing a failure may be explained as follows by referring to FIGS. 5 to 7.

The network apparatus may predict a failure of it. When a failure of the network apparatus is predicted, the network apparatus may transmit to the controller 100 a message notifying that the network apparatus will be down.

That is, when a failure of the network apparatus is predicted, the network apparatus may notify, to the controller 110, information on a time at which the network apparatus will be down and that the network apparatus will be down. Here, a time stamp generated by the network apparatus may be used as the information on the time at which the network apparatus will be down.

Also, the network apparatus may search a storage part in which a list of controllers is stored for a controller 100 related to the network apparatus, and transmit a message notifying the searched controller 100 that the network apparatus will be down.

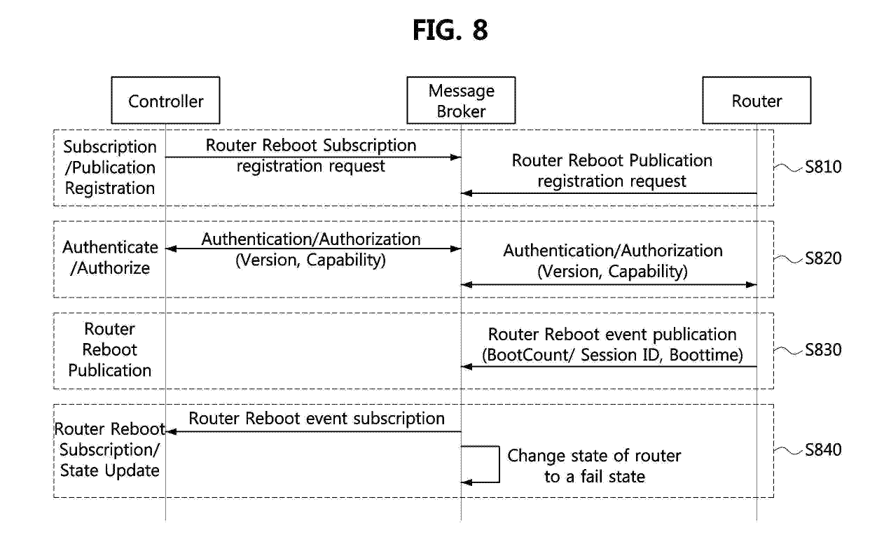

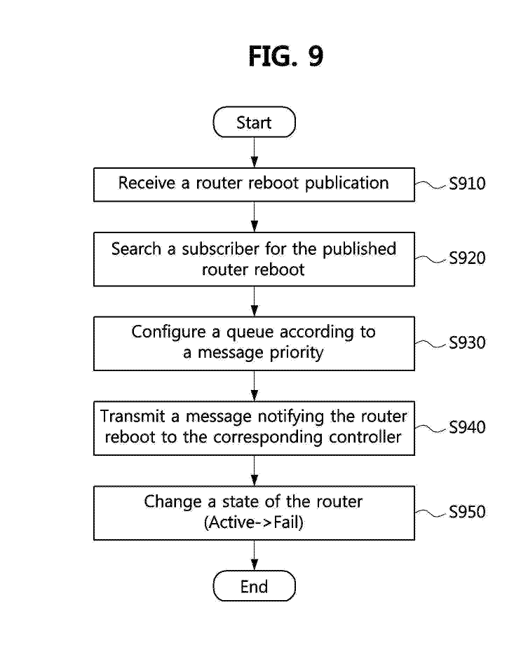

FIG. 8 is a sequence chart to explain a method for processing an unpredictable failure of a network apparatus by using a message broker, according to an exemplary embodiment of the present invention, and FIG. 9 is a flow chart to explain a method for processing an unpredictable failure of a network apparatus by using a message broker, according to an exemplary embodiment of the present invention.

Referring to FIG. 8, the method for processing an unpredictable failure of a network apparatus by using a message broker 400, according to an exemplary embodiment of the present invention, may comprise a step S810 of subscription/publication registration, a step S820 of authentication/authorization, a step S830 of router failure publication, and a step S840 of router failure subscription. Here, each step of FIG. 8 may correspond to each step of FIG. 4.

Specifically, the controller 100 may request registration of subscription of a router reboot to the message broker 400, the router 200 may request registration of publication of a router reboot to the message broker 400 (S810).

Each of the controller 100 and the router 200 having registered the subscription and publication with the message broker 400 may perform authentication on each other, and perform requests and assignments of rights according to a role of each (S820).

The router 200 may publish a router reboot event to the message broker 400 according to a reboot of the router 200 (S830).

Accordingly, the message broker 400 may transfer a router reboot event to the controller 100 having requested the subscription, and change a state of the corresponding router 200 into a failure state (S840).

FIG. 9 explains the steps S830 and S840 of FIG. 8 more specifically.

Referring to FIG. 9, the router 200 may publish a router reboot event, and the message broker 400 may notify the router reboot event to the controller 100. Also, the message broker 400 may change a state of the corresponding router 200 into a failure state.

The message broker 400 may receive the publication of the router reboot event, and record the event in a message log (S910).

The message broker 400 may search publish/subscribe relation information for a controller which is a subscriber related to the corresponding router (S920).

Also, the message broker 400 may put a message to be transmitted to the controller into a transmission queue according to a priority of the message, and notify the failure of the router to the controller 100 (5930, 5940). Here, the message is put into the transmission queue and processed according to its priority so that an emergent or important message having a higher priority can be transmitted without delay or loss.

Also, the message broker 400 may transmit a message including information on session ID, boot count, boot time, etc. to the controller 100, so as to inform the controller 100 of the number of reboots and a time at which the reboot is performed due to the router failures, even when the controller 100 cannot receive information on the router failure and the reboot.

Finally, the message broker 400 may change a state of the router having restarted into a failure state (S950).

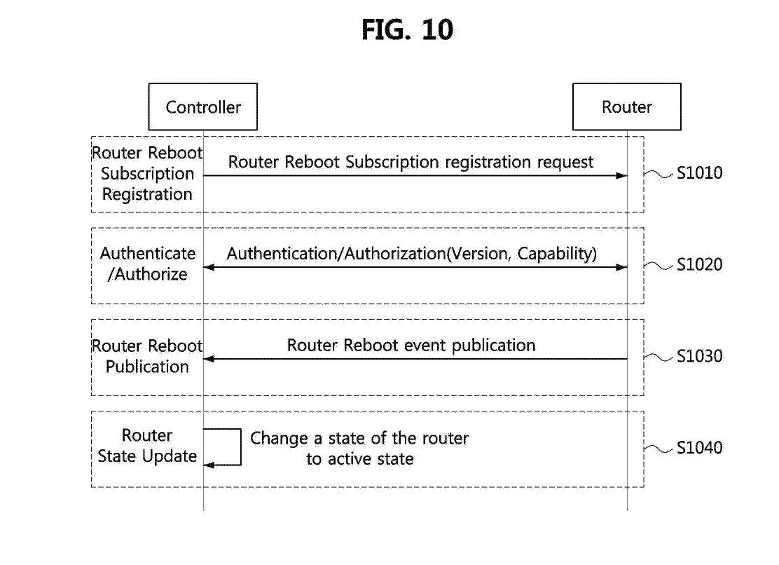

FIG. 10 is a sequence chart to explain a method for processing an unpredictable failure of a network apparatus without a message broker, according to an exemplary embodiment of the present invention.

Referring to FIG. 10, differently from the exemplary embodiment in FIG. 8, the controller 100 and the router 200 may process a reboot according to a failure of the router 200 through direct information exchange between the controller 100 and the router 200, without a message broker 400 relaying message transmissions between the controller 100 and the router 200.

That is, the controller 100 and the route 200 may directly perform authentication on each other, and respectively manage connection information with each other.

Specifically, the method for processing an unpredictable failure of a network apparatus without a message broker 400, according to an exemplary embodiment of the present invention, may comprise a step S1010 of subscription/publication registration, a step S1020 of authentication/authorization, a step S1030 of router failure publication, and a step S1040 of router failure subscription. Here, each step of FIG. 10 may correspond to each step of FIG. 4.

The controller 100 may request registration of subscription of a router reboot event to the router 200 (S1010).

The controller 100 and the router 200 may perform authentication on each other, and perform request and assignment of rights according to a role of each (S1020).

The router 200 may publish a router reboot event to the controller 100 according to that the reboot of the router (S1030).

The controller 100 may change a state of the corresponding router 200 into a failure state (S1040).

Accordingly, referring to FIGS. 8 to 10, the method for processing a failure, performed by a network apparatus, will be explained as follows.

The network apparatus may recover the failure and restart. Since the restart is caused by the failure of the network apparatus, the network apparatus may transmit information on the restart of the network apparatus to the controller 100. For example, the network apparatus may notify the controller 100 that the failure of the network apparatus occurred unpredictably by using the information on the restart. Also, the network apparatus may notify the controller the failure of the network apparatus based on the number of restarts of the network apparatus according to the information on the restart.

Also, the network apparatus may search the storage part storing the list of controllers for the controller 100 related to the network apparatus, and transmit the information on the restart of the network apparatus to the searched controller 100.

Meanwhile, referring to FIGS. 5 to 10, the method for the controller 100 to process a failure will be explained as follows.

The controller 100 may receive information on the failure of the network apparatus from the network apparatus, and process the failure of the network apparatus by identifying the type of the failure of the network apparatus based on the information on the failure of the network apparatus.

Here, the information on the failure of the network apparatus may include information notifying that the network apparatus will be down, when the failure of the network apparatus is predicted. On the contrary, when the failure of the network apparatus is not predicted, the information on the failure of the network apparatus may include information notifying the restart of the network apparatus.

When the failure of the network apparatus is predicted, the controller 100 may identify the failure of the network apparatus by using the information notifying that the network apparatus will be down, the information including information on a time at which the network apparatus will be down. Here, a time stamp generated by the network apparatus may be used as the information on the time at which the network apparatus will be down.

When the failure of the network apparatus is not predicted, the controller 100 may derive the number of restarts of the network apparatus based on the information on the failure of the network apparatus, and identify the failure of the network apparatus.

After identifying the failure of the network apparatus, the controller 100 may record a message to be transmitted to the network apparatus in which the failure occurs in a log, and hold transmission of the message.

According to the present invention, a processing mechanism for a graceful failure and a crash according to type of a failure is defined whereby all controllers related to a network apparatus in which the failure occurs can rapidly identify information on the failure of the network apparatus.

Also, according to a message priority to which QoS is applied, emergent messages on a failure of a router can be transmitted without delay or loss.

Also, using information on the graceful failure or the crash, after occurrence of the graceful failure or the crash, the messages that the controller wants to transmit to the corresponding network apparatus in which the failure occurs can be recorded in a log, and its transmission can be held, thereby reducing unnecessary trials of retransmissions and loads of the network.

Also, after the network apparatus is normally rebooted, according to a predetermined policy, the messages transmissions of which were held can be transmitted asynchronously for synchronization of messages between the controller and the network apparatus, or the suspended messages can be discarded.

While the example embodiments of the present invention and their advantages have been described in detail, it should be understood that various changes, substitutions and alterations may be made herein without departing from the scope of the invention.

1. A method for processing a failure, performed in a network apparatus connected to at least one controller, the method comprising:
predicting a failure of the network apparatus; and
when the failure of the network apparatus is predicted, notifying the at least one controller that the network apparatus will be down.

2. The method according to claim 1, wherein when the failure of the network apparatus is predicted, the network apparatus notifies the at least one controller that the network apparatus will be down by including information on a time at which the network apparatus will be down.

3. The method according to claim 1, wherein a time stamp generated by the network apparatus is used as the information on the time at which the network apparatus will be down.

4. The method according to claim 1, wherein the notifying the at least one controller that the network apparatus will be down further includes:
searching a storage part storing a list of the at least controller for a controller related to the network apparatus; and
transmitting, to the searched controller, a message notifying that the network apparatus will be down.

5. The method according to claim 1, wherein a message broker relays messages between the at least one controller and the network apparatus.

6. A method for processing a failure, performed in a network apparatus connected to at least one controller, the method comprising:
restarting after recovering a failure; and
transmitting information on the restarting to the at least one controller in order to notify the failure to the at least one controller.

7. The method according to claim 6, wherein, in the transmitting information on the restarting to the at least one controller, an unpredictable failure occurring in the network apparatus is notified to the at least one controller by using the information on the restarting.

8. The method according to claim 6, wherein the failure of the network apparatus is notified to the at least one controller, by including information on a number of restarts of the network apparatus in the information on the restarting.

9. The method according to claim 6, wherein the transmitting information on the restarting to the at least one controller further includes:
searching a storage part storing a list of the at least controller for a controller related to the network apparatus; and
transmitting; to the searched controller, the information on the restarting.

10. The method according to claim 6, wherein a message broker relays messages between the at least one controller and the network apparatus.

11. A method for processing a failure, performed in a network apparatus connected to at least one controller; the method comprising:
receiving information according to a type of a failure occurring in the network apparatus from the network apparatus; and
processing the failure based on the information according to the type of the failure.

12. The method according to claim 11, wherein the information according to the type of the failure includes,
information notifying that the network apparatus will be down, when the failure of the network apparatus is predictable, or
information notifying that the network apparatus has been restarted, when the failure of the network apparatus is unpredictable.

13. The method according to claim 11, wherein, in the receiving information according to the type of the failure, information on a time at which the network apparatus will be down is received, when the failure of the network apparatus is predictable.

14. The method according to claim 13, wherein a time stamp generated by the network apparatus is used as the information on the time at which the network apparatus will be down.

15. The method according to claim 11, wherein, in the receiving information according to the type of the failure, information on a number of restarts of the network apparatus is received when the failure of the network apparatus is unpredictable.

16. The method according to claim 11, wherein, in the processing the failure based on the information according to the type of the failure, transmission of a message to be transmitted to the network apparatus in which the failure occurs is suspended, and the message is recorded in a log.

17. The method according to claim 11, wherein a message broker relays messages between the at least one controller and the network apparatus.
